(19) United States
(12) Patent Application Publication
(10) Pub. No.: US 2009/0327989 A1
(43) Pub. Date: Dec. 31, 2009

(54) Statistical Interconnect Corner Extraction

(76) Inventor: Ren Zhuoxiang, San Jose, CA (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/363,743

(22) Filed: Jan. 31, 2009

Related U.S. Application Data
(60) Provisional application No. 61/025,257, filed on Jan. 31, 2008.

(51) Int. Cl. G06F 17/50

(52) U.S. Cl. 716/12

(57) ABSTRACT

Various implementations of the invention provide methods and apparatuses that consider various inter/intra-die variations. In various implementations, a statistical parameter dimension reduction using linear reduced rank regression (RRR) is applied to dramatically reduce the high-dimensional variation sources while accurately capturing their impact on the resultant performance corners. With various implementations of the invention, an application specific corner finding algorithm is employed, the algorithm comprising timing metrics and an iterative output clustering operation.

### RELATED APPLICATIONS

This application claims priority under 35 U.S.C. § 120 to U.S. Patent Application No. 61/025,257, entitled “Statistical Interconnect Corner Extraction,” filed on January 31^{st}, 2008, which application is incorporated entirely herein by reference.

### FIELD OF THE INVENTION

The invention relates to the field of system verification. More specifically, various embodiments of the invention relate to reducing the number of potential system test sequences by application of non-deterministic automata.

### BACKGROUND OF THE INVENTION

Interconnect delay variations due to process variations are becoming more and more dominant as the process continues to scale. Traditional process corner based analysis has been widely used in industry due to its simplicity. However, such a process corner based approach may result in large errors, since it completely ignores the circuit topology information and the correlation among different process parameters. Additionally, there is no guarantee that the process corners always produce the performance corners.

To capture the statistical interconnect timing variation, a variety of methods have been developed under different contexts. Parameterized and interval-valued model order reduction techniques are proposed to generate compact interconnect simulation models to achieve high runtime efficiency, where the first or second order timing models are generated using the size-reduced model to capture the impacts of the underlying parameters. However, the model generation cost arid the simulation cost using the above model order reduction techniques may be prohibited high. Another method that uses closed form formulas to evaluate the interconnect delay mean and standard deviation are derived. Since the formulas are derived based upon the D211/4.1 metric which can be obtained very efficiently,

Permission to make digital or hard copies of all or part of this work for personal or classroom use is granted without fee provided that copies are not made or distributed for profit or commercial advantage and that copies hear this notice and the Full citation on the first page. To copy otherwise. to republish, to post on servers or to redistribute to lists, requires prior specific permission and/or a lee.

However, the accuracy may be quite erroneous (for near end nodes). A mixed method for variation interconnect timing analysis is proposed in to accelerate the statistical model extractions by combining the nominal AWE results with the simple delay metrics such as D2M, however, the model may not be enough accurate though the extraction cost can be still very high when considering numerous intra-die variations. Considering the above techniques, to the best of our knowledge, there is not a method that is both efficient and effective for evaluating the interconnect timing variations.

The application-specific best/worst corner analysis method has been proposed for performance variation analysis and it is expected to be a suitable alternative of statistical analysis. This method can provide the statistical process corners that correspond to the performance corners, thus the performance corners can be efficiently obtained subsequently. Though the APEX algorithm can also efficiently compute the performance corners, the application-specific corner analysis method has a distinct advantage over the APEX algorithm: even when the performance model (either first order or second order models) is not accurate, it can potentially be used to find accurate process corners that can be simulated to obtain the true performance corners. Similar ideas has been adopted in the interconnect performance corner finding algorithms which is later extended to multi-layer interconnect cases, where the elmore delay metric is used to derive the performance corners in the parameter space. It is not difficult to realize that even when we are using a “bad” performance model for corner finding, the resultant process corners may be very close to the realistic ones, as long as the “bad” performance model can capture the “variation trend” as the true model. Unfortunately, the above interconnect corner finding method does riot consider the statistical distributions of the underlying process parameters and it assumes perfect correlation among all the process parameters, which is typically not true. Additionally, as we will show, the elmore delay may produce inaccurate corners for the near-end nodes.

Various implementations of the invention provide a general methodology for extracting the interconnect best/worst case performance corners, which enables to efficiently capture the effect of numerous inter/intra-die variations during the corner finding procedure. In various implementations, a parameter dimension reduction method is employed to reduce the inter/intra-die variations. As a result, the application-specific corner extraction cost is alleviated.

### SUMMARY OF THE INVENTION

Various implementations of the invention provide methods and apparatuses that consider various inter/intra-die variations. In various implementations, a statistical parameter dimension reduction using linear reduced rank regression (RRR) is applied to dramatically reduce the high-dimensional variation sources while accurately capturing their impact on the resultant performance corners. With various implementations of the invention, an application specific corner finding algorithm is employed, the algorithm comprising timing metrics and an iterative output clustering operation.

These and other features and aspects of the invention will be apparent upon consideration of the following detailed description.

### BRIEF DESCRIPTION OF THE DRAWINGS

The present invention will be described by way of illustrative embodiments shown in the accompanying drawings in which like references denote similar elements, and in which:

FIG. 1 illustrates an illustrative computing environment;

FIG. 2 illustrates a portion of the illustrative computing environment of FIG. 1, shown in further detail;

FIG. 3 illustrates a graph representing an electronic system;

### DETAILED DESCRIPTION OF ILLUSTRATIVE EMBODIMENTS

The disclosed technology includes all novel and unobvious features, aspects, and embodiments of the systems and methods described herein, both alone and in various combinations and sub-combinations thereof. The disclosed features, aspects, and embodiments can be used alone or in various novel and unobvious combinations and sub-combinations with one another.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “determine” to describe the disclosed methods. Such terms are high-level abstractions of the actual operations that are performed. The actual operations that correspond to these terms will vary depending on the particular implementation and are readily discernible by one of ordinary skill in the art.

Some of the methods described herein can be implemented by software stored on a computer readable storage medium, or executed on a computer. Additionally, some of the disclosed methods may be implemented as part of a computer implemented electronic design automation (EDA) tool. The selected methods could be executed on a single computer or a computer networked with another computer or computers. For clarity, only those aspects of the software germane to these disclosed methods are described; product details well known in the art are omitted.

### Illustrative Computing Environment

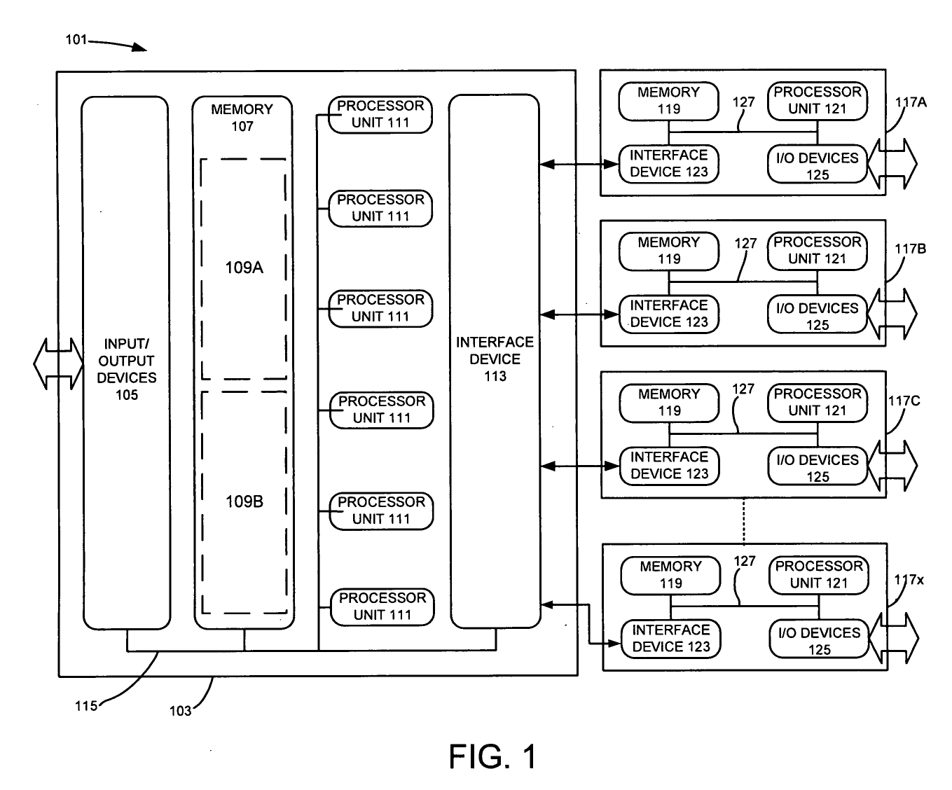

Various embodiments of the invention are implemented using computer executable software instructions executed by one or more programmable computing devices. Because these examples of the invention may be implemented using software instructions, the components and operation of a generic programmable computer system on which various embodiments of the invention may be employed is described. Further, because of the complexity of some electronic design automation processes and the large size of many circuit designs, various electronic design automation tools are configured to operate on a computing system capable of simultaneously running multiple processing threads. The components and operation of a computer network 101 having a host or master computer and one or more remote or slave computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as random access memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom manufactured processor, such as a microprocessor designed to optimally perform specific types of mathematical operations. The interface device 113, the processor units 111, the memory 107 and the input/output devices 105 are connected together by a bus 115.

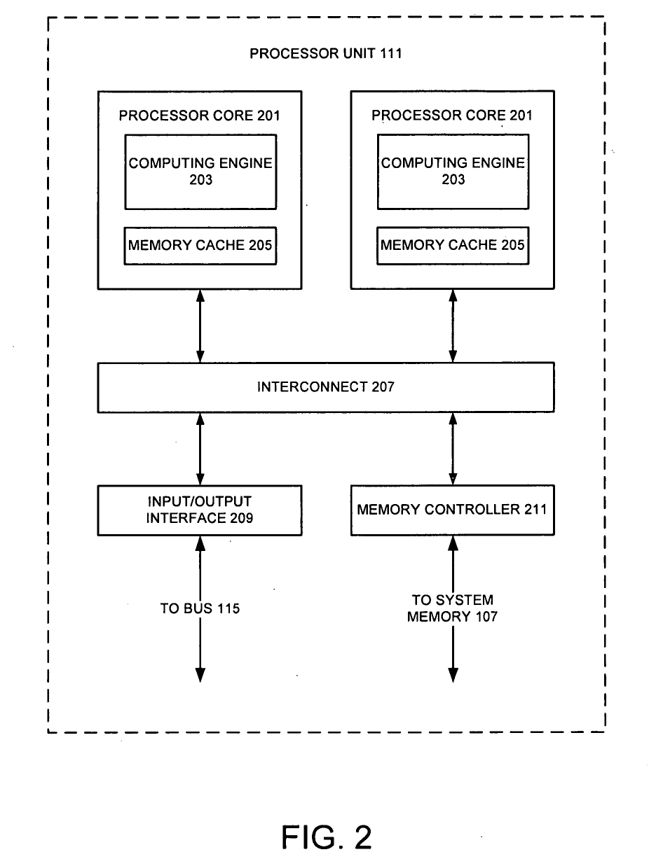

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell Broadband Engine™ (Cell) microprocessor created by Sony Corporation, Toshiba Corporation and IBM Corporation, the interconnect 207 may be implemented as an interconnect bus. With other processor cores 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interfaces 209 and a memory controller 211. The input/output interface 209 provides a communication interface between the processor unit 111 and the bus 115. Similarly, the memory controller 211 controls the exchange of information between the processor unit 111 and the system memory 107. With some implementations of the invention, the processor units 111 may include additional components, such as a high-level cache memory accessible shared by the processor cores 201.

While FIG. 2 shows one illustration of a processor unit 111 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 103 with 128×128 bit registers, four single-precision floating point computational units, four integer computational units, and a 256 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units 111 each having three cores, a multi-core processor unit 111 with four cores together with two separate single-core processor units 111, or other desired configuration.

Returning now to FIG. 1, the interface device 113 allows the master computer 103 to communicate with the slave computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the slave computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each slave computer 117 may include a memory 119, a processor unit 121, an interface device 123, and, optionally, one more input/output devices 125 connected together by a system bus 127. As with the master computer 103, the optional input/output devices 125 for the slave computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the slave computers 117 to communicate with the master computer 103 over the communication interface.

In the illustrated example, the master computer 103 is a multi-processor unit computer with multiple processor units 111, while each slave computer 117 has a single processor unit 121. It should be noted, however, that alternate implementations of the invention may employ a master computer having single processor unit 111. Further, one or more of the slave computers 117 may have multiple processor units 121, depending upon their intended use, as previously discussed. Also, while only a single interface device 113 or 123 is illustrated for both the master computer 103 and the slave computers 117, it should be noted that, with alternate embodiments of the invention, either the master computer 103, one or more of the slave computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as random access memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the slave computers 117 may alternately or additions be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only and is not intended to suggest any limitation as to the scope of use or functionality of alternate embodiments of the invention.

### Process Variation Models

For interconnect circuits, the global variables (inter-die variation sources) typically refer to the process parameters such as the dielectric thickness (Hi) and the dielectric constants (εi) for metal layer i. On the other hand, the process parameters such as the metal width (Wi) and metal thickness (Ti) for metal layer i are usually modeled as the local variables (intra-die variation sources), since these process parameters are usually not perfectly correlated. To accurately model the spatial correlation of these local process variables, the interconnect circuit have to be divided into smaller grids and let the process parameters within the same grid share the same local variables. The grid size for local variables can be determined by examining the correlation length of the underlying process parameters: If the correlation length is too small, the grid size should not be large, otherwise the correlation model may exhibit large errors, which consequently result in a large number of local variables. For example, if we consider the process variations on the dielectric thickness (H), the metal width (W) and the metal thickness (T) for a three-layer interconnect circuit, there are three global variables (three Hi variations) and 6M (3 layer x2 process parameters xM grids) local variables. In this disclosure, multivariate normal distribution for all the variation sources is assumed. Although the method and apparatuses provided are applicable to abnormal distributions.

Various implementations of the invention employ the standard modified nodal analysis (MNA) equations to describe an interconnect network and consider a set of nₚ local and global geometrical variation variables: \vec{p}=[p₁, p₂, . . . , pₙ_{ₚ}]^{T} that impact the system equations:

$$\{ \begin{matrix}( G ( \vec{p} ) + sC ( \vec{p} ) ) x = Bu \\ y = {L}^{T} x\end{matrix} \qquad ( 1 )$$

In Equation (1), uεRⁿ and yεR^{m} represent the inputs and outputs, while xεR^{N} represents the system unknowns. The parametric conductance and capacitance matrices are defined as follows:

$$\begin{matrix}G ( \vec{p} ) = {G}_{O} + {\sum }_{i} {G}_{i} {p}_{i} & ( 2 ) \\ C ( \vec{p} ) = {C}_{O} + {\sum }_{i} {C}_{i} {p}_{i} & ( 3 )\end{matrix}$$

Where G_{O} and C_{O} in Equations (2) and (3) represent the nominal system matrices while Gᵢ and Cᵢ denote the coefficient matrices due to the underlying parameter pᵢ. The above matrices can be easily setup from an RC sensitivity circuit netlist. For example, BεR^{N×n} and LεR^{N×m} may be the input and output matrices, respectively. The nominal qₜₕ (q=0, . . . ) order transfer function moment of the above system is usually defined as:

m_{q}=(−G_{O}⁻¹C_{O})^{q}G_{O}⁻¹B (4)

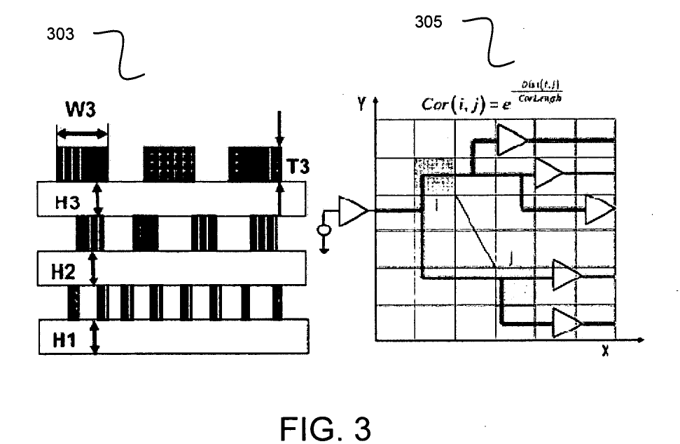

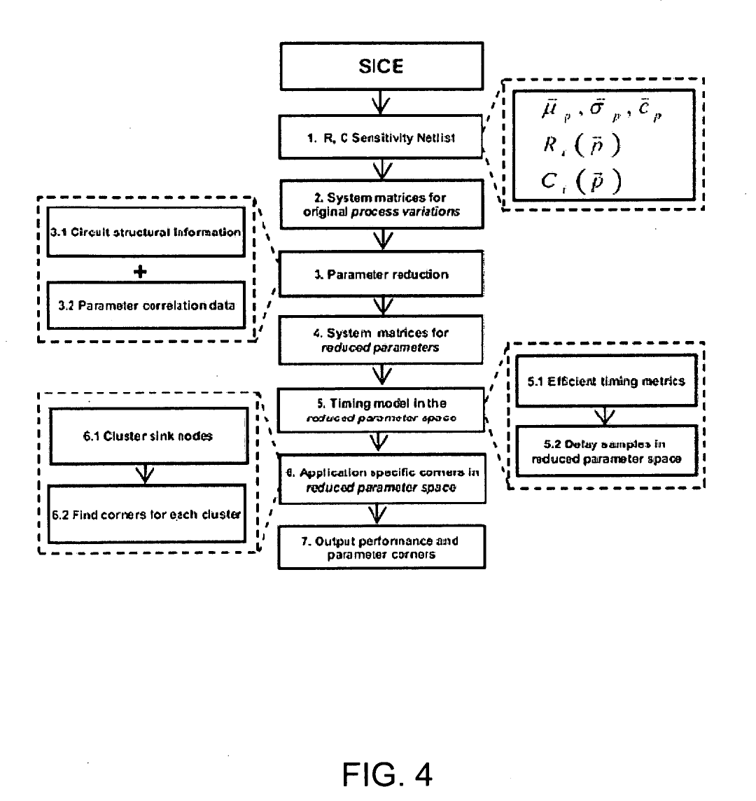

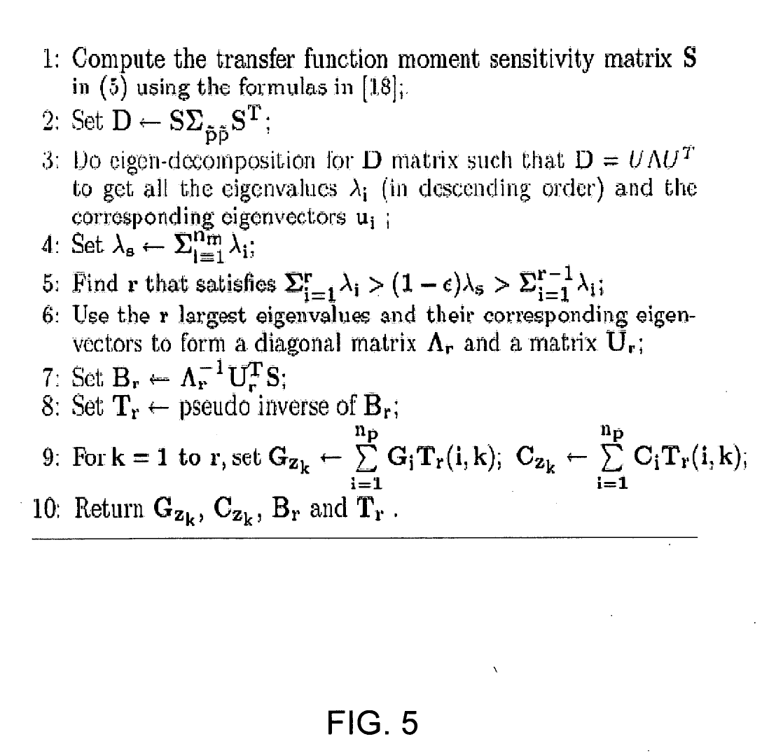

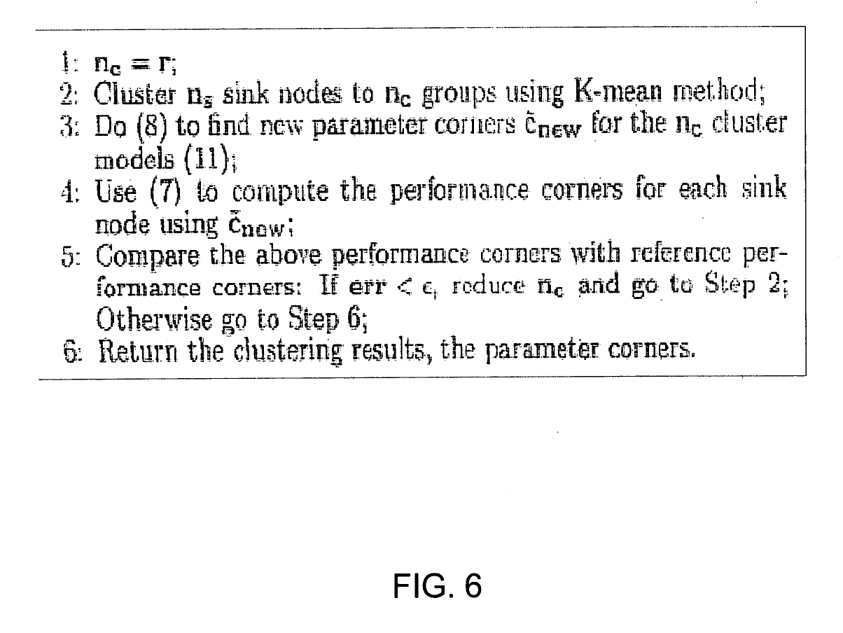

The parametric forms (in terms of the parameter set \vec{p} of the above transfer functions may be readily derived. For example, the first and second order coefficients of \vec{p} can be computed by reusing the LU factorization of the G_{O} matrix. FIG. 3 illustrates a process parameters of a three-layer interconnect 303 and a correlation model 305.

### Statistical Interconnect Corner Extraction

FIG. 4 illustrates a method 401 that may be implemented according to various embodiments of the present invention. The input netlist to the method 401 defines the nominal R, C values as well as their sensitivity values for the underlying process parameters such as the dielectric thickness (H), the metal width (W) and the metal thickness (T) for layers. The netlist also defines the mean and standard deviation of each parameter, as well as the correlation lengths of the local variables such as T and W. In various implementations of the invention, EDA tools may provide such sensitivity extraction functionality. For instance, to extract the parasitic sensitivity netlist for a three-layer interconnect, one nominal extraction plus nine perturbed extractions (perturbed parasitic extractions on H, W and T of three layers, respectively) are needed.

Once the R, C sensitivity netlist is obtained, the nominal and sensitivity matrices in (1) can be calculated easily. We apply the parameter dimension reduction (3) algorithm to reduce the performance model generation (5) cost and the process corner finding (6) effort. Subsequently, the first or second order performance models (response surface models) can be efficiently generated by sampling in the reduced parameter space, using a simple tinning metric (standardized D2M metric). Later on, we cluster the performance corners by looking at their corresponding parameter corners (Initially, each sink node is considered as a performance, while each performance has a pair of best/worst case process corners), such that some of the corners can be merged safely without impacting the true performance corners.

The above performance corners can be generated for any specific confidence level. For instance, if 99% confidence regions for all the parameters are to be covered, the corner finding algorithm can produce the 99% performance confidence region. In various implementations of the invention, a comparison of the performance corners with a Monte Carlo Analysis is made. The outputs of the method 401 can be of various types. Two types of output are described below.

### Process Corners

The method 401 is able to generate the process corners for each performance cluster obtained in Step 6, telling how to set the process parameter valises for the performance corners. For example, these process corners may tell that by perturbing the valises of the dielectric thickness (H), metal width (W) and metal thickness (T) of a specific grid, you can get the best worst case delays/slews for this circuit.

### SPICE Netlist

The method 401 can also generate the SPICE-like netlists containing all the R, C values that will produce the performance corners. Such netlists can be further combined with transistor circuits for the worst stage delay characterization, where model order reduction techniques can be also applied to improve the efficiency.

### Parameter Dimension Reduction

Various implementations of the invention employ the linear reduced rank regression (RRR) methodology to reduce the interconnect parameter dimension. The covariance matrix Σ_{\vec{p}\vec{p}} of the local and/or global process parameters is constructed using the distance based correlation model as shown in FIG. 3. An error tolerance ε, which may be user defined, is used to truncate the reduced parameter set by keeping only the top few dominant reduced parameters in \vec{z}. For an RC interconnect circuit, only the first order sensitivities of the transfer function moments for \vec{p} are needed in parameter reduction, which can be computed by reusing the LU factorization of the nominal conductance matrix G_{O} of Equation (1). As a result, the sensitivity matrix SεRⁿ^{ₘ}^{×n}^{ₚ}, then the transfer function moments (\vec{m}εRⁿ^{ₘ}) of the sink nodes can be expressed as:

\vec{m}(\vec{p})≈\vec{m}_{O}+S_{\vec{p}} (5)

FIG. 5 illustrates a method 501 that may be implemented according to various embodiments of the present invention. The method 501 may be employed to reduce the interconnect parameters, which transforms the original sensitivity matrices Gᵢ and Cᵢ from Equations (2) and (3) into the derived sensitivities G_{zi} and C_{zi}, which yields an alternative parametric system:

$$\{ \begin{matrix}( G ( \vec{z} ) + sC ( \vec{z} ) ) x = Bu \\ y = {L}^{T} x\end{matrix} \qquad ( 6 )$$

Compared with Equation (1), Equation (6) has fewer parameters. The method 501 also generates the parameter reduction mapping matrix Bᵣ, which maps the original parameter \vec{p} to the reduced parameter set by \vec{z}=Bᵣ\vec{p}. A unique feature of these reduced parameters given by the method 501 is that they are uncorrelated normal variables with N(0, 1) distributions. The inverse mapping matrix Tᵣ which is the pseudo inverse of Bᵣ, maps \vec{z} to \vec{p} by \vec{p}=Tᵣ\vec{z}. The reduced parameters (\vec{z}) can significantly simplify the timing model generation, application-specific interconnect corner extraction and the process corner clustering procedures. Additionally, by using the mapping matrix Tᵣ, we are able to map the process corners in \vec{z} to the original process corners in \vec{p}.

### Parametric Model Timing

Returning to FIG. 4. Once the reduced parameter set \vec{z}, the interconnect timing model can he parameterized, as illustrated in (5) of the method 401. In various implementations of the invention, statistical modeling techniques, such as design of experiment (DOE) or Latin hyper cube samplings (LHS) are employed.

As integrated circuit manufacturing technology shrinks the size of device, the interconnect parameter variations are expected to be large, for example σ>10%. As a result, quadratic interconnect timing models are essential for capturing the nonlinear performance variations due to the underlying process parameters. A typical model requires 0(nₚ²) data samples to generate. However, existing interconnect simulation methods are usually impractical to utilize due to the high simulation cast. On the other hand, it is not necessary to build an absolutely accurate model in order to find the process corners that correspond to the performance corners.

In various implementations of the invention, an interconnect designed for the 65 nm technology, where the dielectric thickness, the metal width and thickness variations are considered. The RC sensitivities due to these parameters are calculated using the close form formulas and the RC elements are divided into a few grids for intra-die correlation modeling purpose. With various implementations of the invention, an application-specific corner finding procedure may generate a quadratic timing model, where Y=(Yₜ−\vec{Y}ₜ)/σ_{Yt}.

### Interconnect Corner Extraction

Various implementations of the invention provide methods and apparatuses for finding the application-specific corners for an interconnect circuit.

### Application-Specific Corner Analysis

Once the quadratic timing models for all sink nodes (assume there are nₛ sinks) are generated, we can follow the corner extraction methodology to find nₛ pairs of best/worst process corners. With various implementations of the invention, the quadratic timing model in the reduced parameter space \vec{z}. for sink node k is given by:

Yₖ(\vec{z})=\vec{z}^{T}Aₖ\vec{z}+Bₖ^{T}\vec{z}+Cₖ (7)

Where Aₖ, Bₖ, and Cₖ in Equation (7) are the second order, first order constant coefficients. The application-specific corner extraction for sink node k can he formulated as the following optimization problem:

max/min{Yₖ(\vec{z})=\vec{z}^{T}Aₖ\vec{z}+Bₖ^{T}\vec{z}+Cₖ},s.t.∥\vec{z}∥=α (8)

Where α is used to define the confidence region of the parameter space. As discussed above, all the reduced parameters in \vec{z} are uncorrelated normal variables with N(0, 1) distributions. Therefore, the concept of ellipsoid confidence region of \vec{p} now becomes a hypersphere confidence region of \vec{z}. The confidence level of the corners found by Equation (8) can be adjusted by setting α to a different value or values. More specifically, since the reduced variables in \vec{z} are independent, then the probability density function (pdf) of \vec{z} becomes:

$$pdf ( \vec{z} ) = {( 2 π )}^{- \frac{n}{2}} {e}^{- \frac{1}{2} {\vec{z}}^{T} \vec{z}} = {( 2 π )}^{- \frac{n}{2}} {e}^{- \frac{1}{2} {‖ \vec{z} ‖}^{2}} \qquad ( 9 )$$

As can be seen, the pdf of \vec{z} may be determined by α²=∥\vec{z}∥², which has a chi-square distribution with degree r. To obtain the corners for a desired confident region via Equation (8), one may compute α² by evaluating the inverse of the cumulative distribution function (cdf) of

$${‖ \vec{z} ‖}^{2} = {\sum }_{k = 1}^{r} {z}_{k}^{2} .$$

It is important to note that the optimization problem in Equation (8) may be solved in the reduced parameter space, which typically has a much lower dimensionality, thus the corner finding efficiency can be significantly improved than ever before.

### Iterative Sink Node Clustering

Returning again to FIG. 4, the method 401 includes a operation for clustering the nₛ pairs of best/worst corners. In various implementations of the invention, the clustering is done in the reduced parameter space. By for example, clustering the 2nₛ best/worst parameter corners. For each sink node k, a vector, which includes the best/worst parameter corners may be formed as follows:

$${\vec{C}}_{k} = [ \begin{matrix}{C}_{bst} , k \\ {C}_{wst} , k\end{matrix} ] \qquad ( 10 )$$

With various implementations of the invention, the K-mean algorithm is employed to cluster \vec{Cₖ} for k=1, . . . , nₛ. Still, with various implementations of the invention, a clustering method 601 is employed. The method 601 is illustrated in FIG. 6. As can be seen from this figure, an initial estimate of the number of clusters r is used. Subsequently, the K-mean clustering method is performed. Then the representative performance model for the clusters i are computed as follows:

$${A}_{i}^{′} = {\sum }_{k ∈ Clusteri} {A}_{k} , {B}_{i}^{′} = {\sum }_{k ∈ Clusteri} {B}_{k} \qquad ( 11 )$$

Following which, Equation (8) may be employed to find the best/worst corners for this cluster. Next these new parameter corners are substituted into the timing models of all sink nodes k, to compute the performance corners. The method 601 may be repeated several times. With each repetition, we can determine the minimum number of clusters, without impacting the final corner accuracy. The method 601 additionally includes a step for finding the representative parameter corners for the compact clusters.

### CONCLUSION

Various implementations of the invention provide methods and apparatuses that consider various inter/intra-die variations. In various implementations, a statistical parameter dimension reduction using linear reduced rank regression (RRR) is applied to dramatically reduce the high-dimensional variation sources while accurately capturing their impact on the resultant performance corners. With various implementations of the invention, an application specific corner finding algorithm is employed, the algorithm comprising timing metrics and an iterative output clustering operation.

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

What is claimed is:

1. A computer implemented method of comprising:
identifying a netlist;
reducing the netlists parameters;
determining a system matrix for the reduced netlist parameters;
identifying a timing model for the reduced netlist parameters; and
determining the interconnect corner values for the reduced netlist parameters.
